(19) United States
(12) Patent Application Publication
(10) Pub. No.: US 2006/0051258 A1
(43) Pub. Date: Mar. 9, 2006

(54) Ozone generator

(76) Inventor: Shih-Lan Chiu, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/180,521

(22) Filed: Jul. 14, 2005

(30) Foreign Application Priority Data
Sep. 7, 2004 (TW) 93214239

(51) Int. Cl. B01J 19/08

(52) U.S. Cl. 422/186.07; 422/186.18

(57) ABSTRACT

An ozone generator has an insulating structure, a metallic tube, at least one metallic plate and a metallic rod. The metallic tube forms a passage therein. The metallic tube electrically connects to an anode of high-voltage pulse direct current. The metallic rod connects the at least one metallic plate and is disposed in the passage. The metallic rod electrically connects to a cathode of the high-voltage pulse direct current. In the preferred embodiment the at least one metallic plate has a quantity of more than two. The metallic plates are arranged along a flow direction of the passage in sequence. The high-voltage pulse direct current directly forces a circumference of the at least one metallic plate to perform point discharge, so that oxygen passing through the passage is ionized continuously to produce ozone.

### BACKGROUND OF THE INVENTION

1. Field of the Invention

The present invention relates to an ozone generator, and more particularly, to an ozone generator that uses high-voltage pulse direct current to produce ozone.

2. Description of Related Art

The great progress of industrial development makes human's lives better, but also results a great negative effect to our natural environment. For example, air pollution and water pollution, latent in the environment, cause harm to human beings. To provide safer and more comfortable environment and also improve human's quality of life, manufacturers develop many types of cleaning and disinfecting devices, such as an ozone generator. Ozone has a variety of beneficial effects such as disinfecting, freshening, detoxifying, and deodorizing. It can also be used in a number of medical treatments, beauty and bleaching treatments, and improving air quality. As ozone can be easily reformed as oxygen, ozone generators can be applied broadly to our living and working environments. For example, ozone generators are often applied to a wide variety of objects, such as small tableware drying apparatus or large water treatment plants.

A conventional ozone generator substantially includes quartz or glass with a metallic net, and direct or alternating current is supplied to the ozone generator for ionizing oxygen to produce ozone.

The conventional ozone generator only produces low concentration ozone, and the efficiency thereof is inadequate for equipments that require high standard of completely clean or disinfected. In addition, the conventional ozone generator has a large number of components, and it is large in size and costly to produce.

Accordingly, as above description, the conventional ozone generator still has some drawbacks that could be improved. The present invention aims to resolve the drawbacks in the prior art.

### SUMMARY OF THE INVENTION

The primary object of the invention is therefore to specify an ozone generator that produces ozone more efficiently.

Another object of the invention is therefore to specify an ozone generator, which has fewer materials and parts than conventional types of ozone generators, and thereby the size and cost of the device are both reduced.

According to the invention, the above objects are achieved via an ozone generator comprising an insulating structure, a metallic tube, at least one metallic plate and a metallic rod. The metallic tube is fixed in the insulating structure. The metallic tube forms a passage therein. The passage forms an inlet and an outlet respectively at two ends thereof and a flow direction being defined from the inlet to the outlet. The metallic tube electrically connects to an anode of high-voltage pulse direct current. The metallic rod connects to the at least one metallic plate and is disposed in the passage. The at least one metallic plate and the flow direction are arranged in a crossed manner. A circumference of the at least one metallic plate and the metallic tube form a gap therebetween. The metallic rod has two ends fixed to the insulating structure and is electrically connected to a cathode of the high-voltage pulse direct current.

The metallic rod connects to the at least one metallic plate and is disposed in the passage. The metallic tube and the metallic rod are respectively and electrically connected to the anode and the cathode of the high-voltage pulse direct current. In this way the high-voltage pulse direct current directly forces the circumference of the at least one metallic plate to perform point discharge, so that oxygen passing through the passage is transformed to ozone more efficiently, the materials and parts of the ozone generator are fewer in number, reducing the size and cost of the device.

In the preferred embodiment, the metallic tube is a circular tube, the at least one metallic plate is a circular thin plate, the metallic rod connects to a center of the at least one metallic plate and is located at a central line of the metallic tube, and the at least one metallic plate is perpendicular to the flow direction of the passage, so that oxygen passing through the passage is ionized evenly.

In the preferred embodiment, the at least one metallic plate has a quantity of more than two, the metallic plates are arranged along the flow direction of the passage in sequence, each two of the metallic plates adjacent to each other form an interval therebetween, and the interval is larger than the gap, so that the metallic plates are in series to discharge electricity. In this way oxygen passing through the passage is ionized continuously to produce ozone in a more efficient manner than the prior art.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an exploded perspective view of an ozone generator of the present invention;

FIG. 2 is a front view of an ozone generator of the present invention;

FIG. 3 is a side view of an ozone generator of the present invention;

FIG. 4 is a cross-sectional view taking along line 4-4 of FIG. 3; and

FIG. 5 is a cross-sectional view taking along line 5-5 of FIG. 3.

### DETAILED DESCRIPTION OF THE PREFERRED EMBODIMENTS

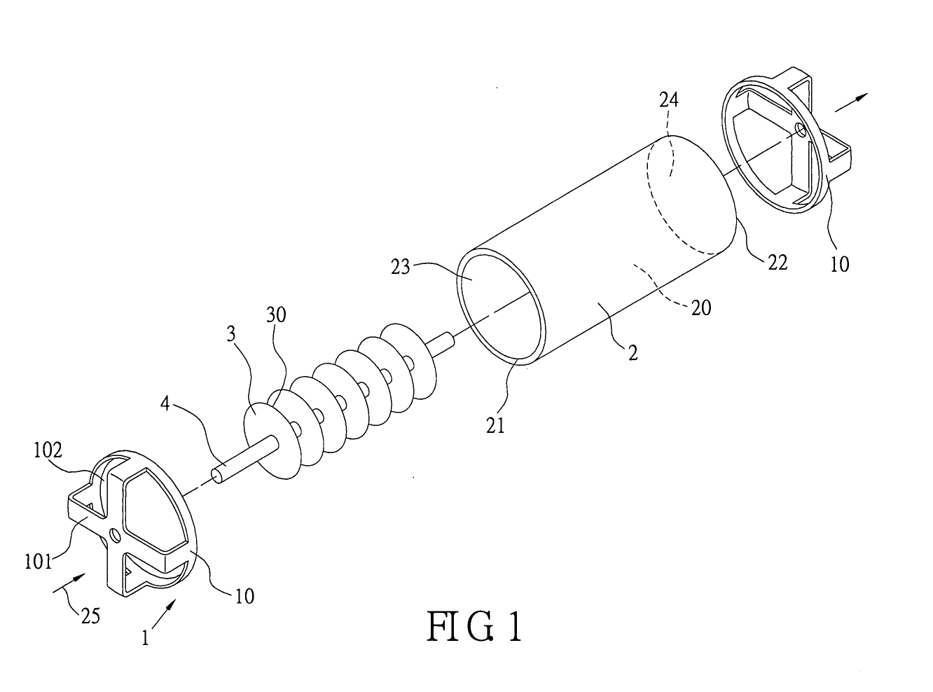

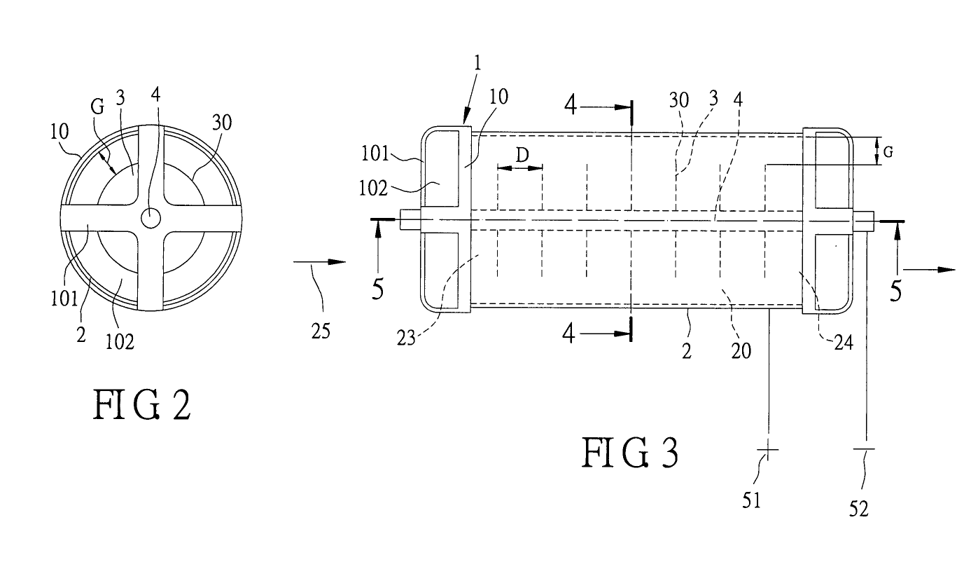

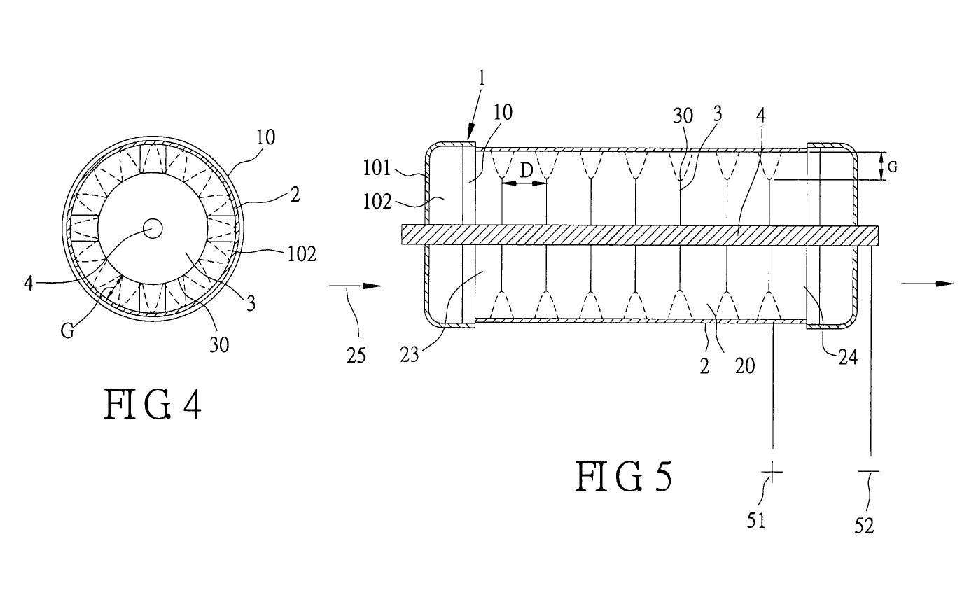

Referring to FIGS. 1-5, the present invention provides an ozone generator. The ozone generator comprises an insulating structure 1, a metallic tube 2, at least one metallic plate 3, and a metallic rod 4.

The insulating structure 1 may have different designs according to the equipment into which the ozone generator of the present invention is installed. In this embodiment, the insulating structure 1 includes two insulating frames 10. Each of the insulating frames 10 has a plurality of symmetrical and crossed ribs 101 forming a plurality of through holes 102 therein.

The metallic tube 2 is fixed in the insulating structure 1. In this embodiment, the metallic tube 2 is a circular tube. The metallic tube 2 has a front edge 21 and a rear edge 22. The two insulating frames 10 respectively connect to the front edge 21 and the rear edge 22 of the metallic tube 2 by using a sticking, screwing or tightening manner. The metallic tube 2 forms a passage 20 therein. The passage 20 forms an inlet 23 and an outlet 24 respectively at two ends thereof. The inlet 23 and the outlet 24 are respectively located at the front edge 21 and the rear edge 22 of the metallic tube 2, and respectively correspond to the through holes 102 of the two insulating frames 10. A flow direction 25 is defined from the inlet 23 to the outlet 24, and the metallic tube 2 electrically connects to an anode of high-voltage pulse direct current 51.

The at least one metallic plate 3 is a circular thin plate in this embodiment and corresponds to the metallic tube 2 which is a circular tube. The shapes of the at least one metallic plate 3 and the metallic tube 2 are not limited to the above embodiment.

The metallic rod 4 is connected to a center of the at least one metallic plate 3 by using solder or conductive glue. The metallic rod 4 is disposed in the passage 20 and is located at a central line of the metallic tube 2. The at least one metallic plate 3 is perpendicular to the flow direction 25 of the passage 20, so that the at least one metallic plate 3 and the flow direction 25 of the passage 20 are arranged in a crossed manner. In addition, a circumference of the at least one metallic plate 3 and the metallic tube 2 form an equidistant annular gap G therebetween. The metallic rod 4 has two ends respectively fixed to the ribs 101 of the two insulating frames 10 of the insulating structure 1, and is electrically connected to a cathode of the high-voltage pulse direct current 52. The dimension of the gap G between the circumference of the at least one metallic plate 3 and the metallic tube 2 may depend on the voltage value of the high-voltage pulse direct current.

When oxygen (O₂) enters the passage 20 from the inlet 23, it flows along the flow direction 25 and through the gap G. The high-voltage pulse direct current directly forces the circumference of the at least one metallic plate 3 to perform point discharge. In this way the circumference of the at least one metallic plate 3 forms a plurality of discharging points 30 thereon to discharge electricity to the metallic tube 2, so that oxygen is ionized and becomes ozone (O₃). In addition, the at least one metallic plate 3 is arranged perpendicular to the flow direction 25 of the passage 20, so that oxygen passing through the passage 20 is ionized evenly. In this embodiment, the at least one metallic plate 3 has a quantity of more than two. The metallic plates 3 are arranged along the flow direction 25 of the passage 20 in sequence. Each two of the metallic plates 3 adjacent to each other and forms an interval D therebetween, and the interval D is larger than the gap G, so that the metallic plates 3 are in series to discharge electricity. Oxygen particles that are not ionized by the first one of the metallic plates 3 continue to flow along the flow direction 25 and may be ionized by the second one of the metallic plates 3 to produce ozone. Oxygen particles that are not ionized by the second one of the metallic plates 3 may be ionized by the third one of the metallic plates 3 to produce ozone. In this manner, oxygen is continuously ionized to produce ozone that emitted through the outlet 24. Indeed, the type of the insulting structure 1 may be changed, and the quantity of the at least one metallic plates 3 may be increased.

As indicated above, the ozone generator of the present invention has the following advantages:

(1) The metallic rod connects to the at least one metallic plate and is disposed in the passage, and the metallic tube and the metallic rod are respectively and electrically connected to the anode and the cathode of the high-voltage pulse direct current, so that the high-voltage pulse direct current directly forces the circumference of the at least one metallic plate to perform point discharge. In this way more ozone is produced more efficiently from oxygen passing through the passage, and the materials and parts of the ozone generator are fewer in number, reducing the size and cost of the device.

(2) The metallic tube is a circular tube, the at least one metallic plate is a circular thin plate, the metallic rod connects to a center of the at least one metallic plate and is located at a central line of the metallic tube, and the at least one metallic plate is perpendicular to the flow direction of the passage, so that oxygen passing through the passage is ionized evenly.

(3) In the preferred embodiment the at least one metallic plate has a quantity of more than two, the metallic plates are arranged along the flow direction of the passage in sequence, each two of the metallic plates adjacent to each other form an interval therebetween, and the interval is larger than the gap, so that the metallic plates are in series to discharge electricity, so that oxygen passing through the passage is ionized continuously to produce ozone, and ozone is produced more efficiently.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An ozone generator comprising:
an insulating structure;
a metallic tube fixed in the insulating structure, the metallic tube forming a passage therein, the passage forming an inlet and an outlet respectively at two ends thereof and a flow direction being defined from the inlet to the outlet, and the metallic tube electrically connecting to an anode of high-voltage pulse direct current;
at least one metallic plate; and
a metallic rod connecting to the at least one metallic plate and being disposed in the passage, the at least one metallic plate and the flow direction being arranged in a crossed manner, a circumference of the at least one metallic plate and the metallic tube forming a gap therebetween, and the metallic rod having two ends fixed to the insulating structure and being electrically connected to a cathode of the high-voltage pulse direct current.

2. The ozone generator as claimed in claim 1, wherein the at least one metallic plate is perpendicular to the flow direction of the passage.

3. The ozone generator as claimed in claim 2, wherein the metallic tube is a circular tube, the at least one metallic plate is a circular thin plate, and the metallic rod connects to a center of the at least one metallic plate and is located at a central line of the metallic tube.

4. The ozone generator as claimed in claim 2, wherein the at least one metallic plate has a quantity of more than two, the metallic plates are arranged along the flow direction of the passage in sequence, each two of the metallic plates adjacent to each other form an interval therebetween, and the interval is larger than the gap.

5. The ozone generator as claimed in claim 1, wherein the insulating structure includes two insulating frames, the metallic tube has a front edge and a rear edge, the two insulating frames respectively connect to the front edge and the rear edge of the metallic tube, and the inlet and the outlet are respectively located at the front edge and the rear edge of the metallic tube.

6. The ozone generator as claimed in claim 5, wherein each of the insulating frames of the insulating structure has a plurality of symmetrical and crossed ribs forming a plurality of through holes therein, and the inlet and the outlet respectively correspond to the through holes of the two insulating frames.
